(19) United States
(12) Patent Application Publication
(10) Pub. No.: US 2003/0174698 A1
(43) Pub. Date: Sep. 18, 2003

(54) NXN switch fabric partitioning

(76) Inventors: Martin LaRose, Ottawa (CA); Denis Gallant, Dunrobin (CA); Alain Brazeau, Ottawa (CA); Don Asquin, Ottawa (CA)

Correspondence Address: MARKS & CLERK, P.O. BOX 957, STATION B, OTTAWA, ON, K1P 5S7, CA

(21) Appl. No.: 10/387,383

(22) Filed: Mar. 14, 2003

Related U.S. Application Data
(60) Provisional application No. 60/364,111, filed on Mar. 15, 2002.

(51) Int. Cl. H04Q 11/00

(52) U.S. Cl. 370/386; 370/389

(57) ABSTRACT

A switch fabric architecture for a telecommunications system is described. In a basic aspect of the invention a N×N switch fabric and associated line cards are combined into a single shelf. In a 2N×2N switch fabric architecture, two shelves, each having a 2N×2N switch fabric with associated line cards, and 2:1 and 1:2 selectors are interconnected with inter-shelf cabling and in a 4N×4N switch fabric architecture, four such shelves are interconnected with appropriate inter-shelf cabling.

This application claims the benefit under 35 USC 119(e) of U.S. Provisional Application No. 60/364,111 filed Mar. 15, 2002

### FIELD OF THE INVENTION

This invention relates to telecommunications systems and more particularly to the design of switching equipment for telecommunications systems.

### BACKGROUND

Telecommunications providers are facing a more and more dynamic environment. As customer bandwidth requirements increase and more data ports are required the provider must be able to modify and scale their network. In this dynamic environment switching fabrics need to be designed to be easily scalable. As the provider modifies and scales their network the installed base of services must not be affected—it must be able to continue to generate revenue while the rest of the network is changed. The dynamic nature of the network also requires any scaling technique to be non-blocking, that is any input can be connected to any unused output without affecting other inputs and outputs. The common approach to solving the problem is to use a centralized fabric design (e.g. fabric shelf) and interconnect to the line card ports in a star fashion.

The shortcomings of this solution are:

1. The centralized fabric design adds more equipment and consequently increases cost in the shelves.

2. The centralized fabric design infrastructure does not scale easily (i.e. to expand a system either equipment needs to be torn out or underutilized equipment is initially installed).

3. The centralized fabric design requires more inter-shelf cables to implement.

### SUMMARY OF THE INVENTION

The problem solved by the invention is how to partition the N×N Switch Fabric within the system such that it can be efficiently expanded to multiple shelves for a larger fabric arrays. The invention proposes a way of distributing the Switch Fabric across the shelves such that the same shelf is efficiently used for N×N, 2N×2N, and 4N×4N systems.

The basic concept of the proposed solution is to combine Switch Fabric Cards and Line Cards into the same shelf. To upgrade from an N×N system to a 2N×2N system, to a 4N×4N system, the same basic shelf is efficiently reused in all systems; only a higher density Fabric Card is added for the 2N×2N and 4N×4N systems. Additionally the proposed solution requires less inter-shelf cabling and infrastructure than a conventional system.

Therefore in accordance with a first aspect of the invention there is provided a switch fabric architecture for a telecommunications system comprising: a N×N switch fabric card; and associated line cards; wherein the switch fabric card and associated line cards are combined into a single shelf.

In accordance with a second aspect of the invention there is provided a scalable switch fabric architecture for a telecommunications system comprising: a 2N×2N switch fabric card; associated line cards; N×1:2 selectors; and N×2:1 selectors; wherein the switch fabric card, associated line cards and selectors are combined into a single shelf.

In preferred embodiments of this aspect of the invention two shelves are interconnected with inter-shelf cabling to form a 2N×2N switch fabric architecture, or four shelves are interconnected with inter-shelf cabling to form a 4N×4N switch fabric architecture.

### BRIEF DESCRIPTION OF THE DRAWINGS

The invention will now be described in greater detail with reference to the attached drawings wherein:

FIG. 1 illustrates a prior art line card and N×N switch fabric architecture;

FIG. 2 illustrates a prior art line card and 4N×4N switch fabric system using 2N×2N fabric shelves;

FIG. 3 shows a line card and switch fabric shelf according to the invention;

FIG. 4 shows a line card and 2N×2N switch fabric architecture; and

FIG. 5 shows a line card and 4N×4N switch fabric architecture.

### DETAILED DESCRIPTION OF THE INVENTION

Rather than building a system that consists of shelves that are strictly for switch fabrics and shelves that are strictly for Line Cards the invention combines Switch Fabrics and Line Cards on each shelf of the system. In this architecture, only one efficient shelf design is required as the system is expanded.

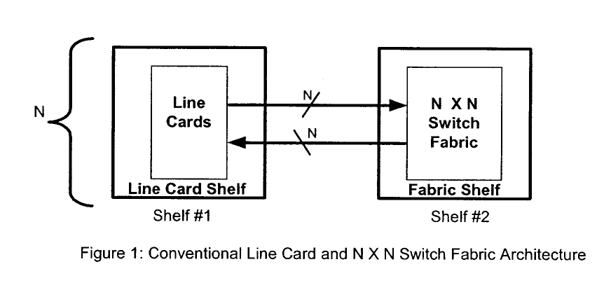

FIG. 1 shows the design and interconnection of a conventional N×N switching fabric system. Multiple shelves, and their support infrastructure (cooling, power distribution etc.) as well as 2N inter-shelf connections are needed to implement the architecture. If the Switch Fabric is 2N×2N then 2*2N inter-shelf connections would be required.

If a conventional architecture was designed to use the same shelves for an N×N, 2N×2N and 4N×4N system, then the Switch Fabric shelf could be sized to handle a 4N×4N Switch Fabric, and the Line Card Shelf could be sized to handle 4N Line Cards. To one skilled in the art, it will be apparent that in the initial N×N system a large amount of the infrastructure is underutilized. This underutilization will add to the initial installation cost of the system. In the proposed solution, the system scales with the switch fabric's size. An N×N system uses only the infrastructure it needs; there is no underutilization.

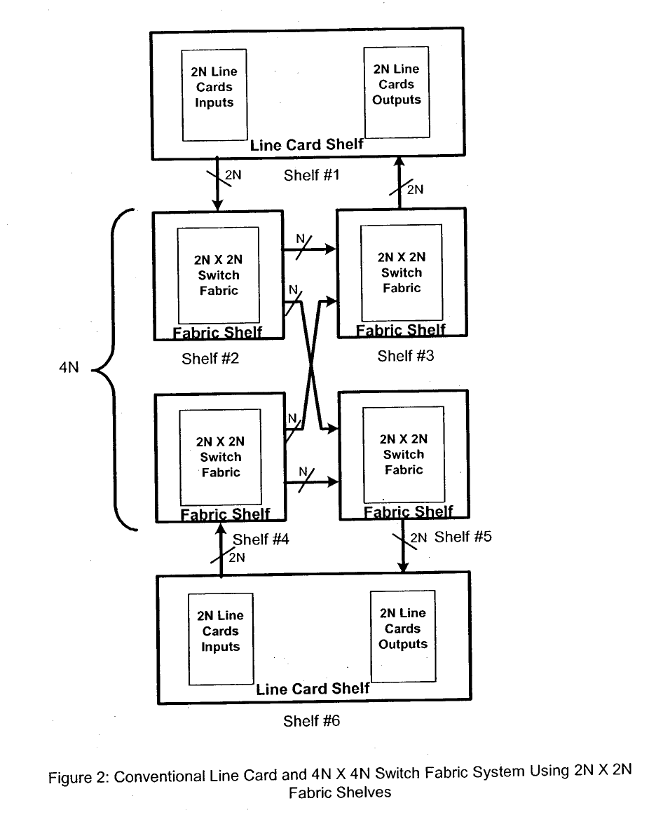

FIG. 2 shows how a conventional architecture could be designed as a compromise using 2N×2N Switch Fabric shelves and 2N Line Card shelves. For N×N systems there would be underutilized infrastructure. Further, if the system is expanded to a 4N×4N system, then additional shelves are needed for a total of 4 2N×2N Switch Fabric Shelves and 2, 2N Line Card Shelves, with 12N inter-shelf cables. Clearly, a conventional architecture, based on an N×N fabric shelf, would become unmanageable in a 4N×4N system as there would be so many shelves and inter-shelf cables required.

In the conventional approach to scalability, the increased number of shelves requires more support infrastructure including cooling systems, power breakers and distribution, EMI (electromagnetic interference) shielding, and intershelf cabling. This additional material is more expensive to design and manufacture, more expensive to purchase, more complex to install and provision, more complicated to maintain, and more prone to failures. The increased number of shelves takes up more space in the provider's already full central office. Additionally, the complexity of the system requires more highly skilled personnel who are more costly to the provider.

Reducing the number of shelves required in scaling the network, while still maintaining a non-blocking fabric will lower the telecommunications provider's operating costs.

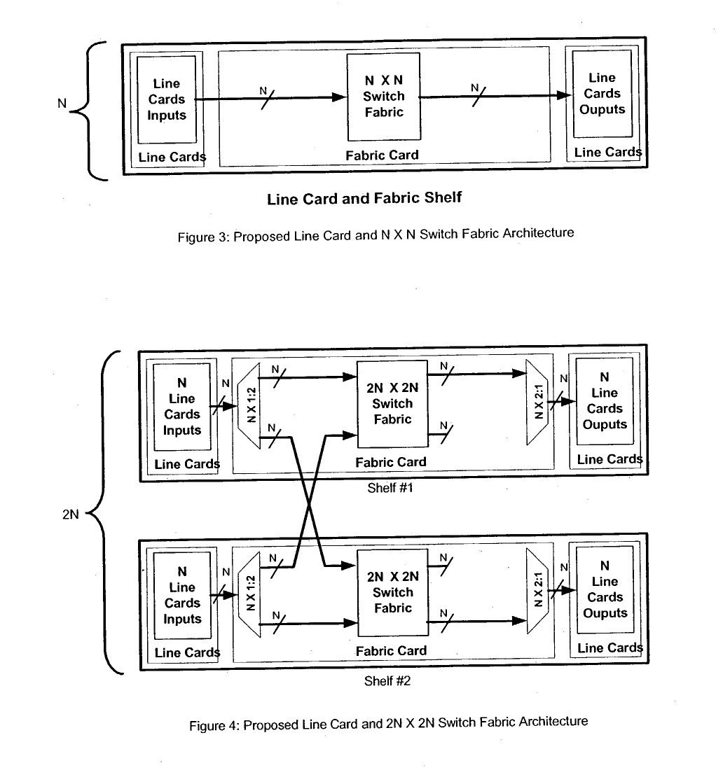

FIG. 3 shows that in the proposed solution the N×N Switch Fabric and Line Cards are combined into one shelf, reducing or eliminating infrastructure and inter-shelf cabling requirements. As shown in FIG. 3 the N×N Switch Fabric is connected to the line card inputs by N connectors and to the line card outputs by N connectors.

FIG. 4 shows an implementation of a 2N×2N Switch Fabric according to one aspect of the present invention The same shelf as used in the single shelf (N×N) solution is used, except that the Switch Fabric Card is changed. In order to implement the 2N×2N Switch Fabric each Switch Fabric Card is upgraded to contain an 2N×2N Switch Fabric with an array of N1:2 selectors, and an array of N2:1 selectors. While the N 2:1 selectors are unused in the configuration of FIG. 4, they will be utilized in further expansion of the proposed solution. The Switch Fabric on each Fabric Card is made 2N×2N because it is receiving N inputs onshelf and N inputs off-shelf. Although the proposed 2N×2N system shown in FIG. 4 could utilize 2N×N Switch Fabrics it uses 2N×2N Switch Fabrics to allow for easy expansion to a 4N×4N system. In the proposed solution, intershelf cabling for a 2N×2N system is 2N; where as a conventional system would require a minimum of 4N intershelf cables.

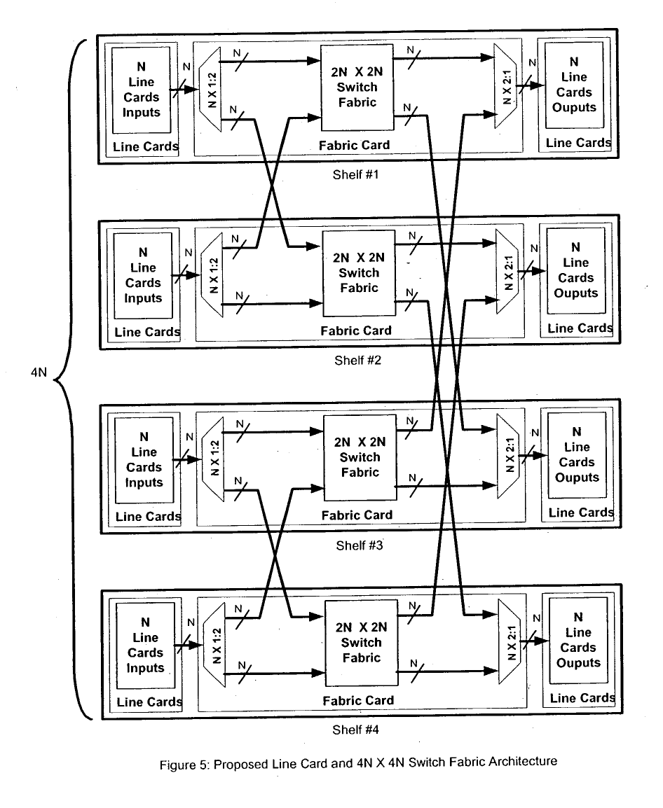

FIG. 5 shows the proposed solution's implementation of a 4N×4N Switch Fabric. The same shelves are used as in the single shelf solution; only the Switch Fabric Card is changed. The Switch Fabric Card used in the 4N×4N Switch Fabric is the same as used in the 2N×2N solution, only additional shelves and intershelf cabling is required. In the 4N×4N the N 2:1 selectors on each Fabric Card are used to receive data streams from other shelves in the system. In the proposed solution based, on 2N×2N a Switch Fabric, intershelf cabling for a 4N×4N system is 8N, 4N less than the conventional architecture shown in FIG. 2, also based on a 2N×2N fabric.

By way of example consider two systems, the first as shown in FIG. 4. If the total size of the fabric (2N) is 256×256 then N=256/2=128. Each Switch Fabric Card contains a 256×256 Fabric Switch. The number of inter-shelf fabric cables would need to be 2N=256. This number compares with 2*(2N)=512 inter-shelf fabric cables in a conventional system. In a second example, consider the system as shown in FIG. 5. If the total size of the fabric is 512 then N=512/4=128. The same Fabric Cards are used, each containing a 2N×2N or 256×256 Fabric Switch. The number of inter-shelf fabric cables would be 8N=1024. A conventional system based on a 2N×2N Switch Fabric, as shown in FIG. 2, will use 12*N=12*128=1536 inter-shelf cables.

While particular embodiments of the invention have been described and illustrated it will be apparent to one skilled in the art that numerous changes can be made to the basic concept. It is to be understood, however, that such changes will fall within the full scope of the invention as defined in the appended claims.

We claim:

1. A switch fabric architecture for a telecommunications system comprising:
a N×N switch fabric card; and
associated line cards;
wherein the switch fabric card and associated line cards are combined into a single shelf.

2. A scalable switch fabric architecture for a telecommunications system comprising:
a 2N×N switch fabric card;
associated line cards; and
N×1:2 selectors;
wherein the switch fabric card, associated line cards and selectors are combined into a single shelf.

3. The scalable switch fabric architecture as defined in claim 2 wherein said switch fabric card is a 2N×2N switch fabric card.

4. The scalable switch fabric architecture as defined in claim 2 further having N×2:1 selectors.

5. The scalable switch fabric architecture as defined in claim 3 further having N×2:1 selectors.

6. The switch fabric architecture as defined in claim 1 having N interconnecting connectors.

7. The scalable switch fabric architecture as defined in claim 2 wherein two shelves are interconnected with inter-shelf cabling to construct a 2N×2N switch fabric architecture.

8. The scalable switch fabric architecture as defined in claim 7 having 2N intershelf cables.

9. The scalable switch fabric architecture as defined in claim 3 wherein two shelves are interconnected with inter-shelf cabling to construct a 2N×2N switch fabric architecture.

10. The scalable switch fabric architecture as defined in claim 5 wherein four shelves are interconnected with inter-shelf cabling to construct a 4N×4N switch fabric architecture.

11. The scalable switch fabric architecture as defined in claim 10 having 4N inter-shelf cables.
